(19) United States
(12) Patent Application Publication
(10) Pub. No.: US 2017/0025663 A1
(43) Pub. Date: Jan. 26, 2017

(54) EXTERNAL CONNECTOR OF VEHICLE BATTERY PACK

(71) Applicant: LSIS CO., LTD., Anyang-si (KR)

(72) Inventor: Kyooseok KIM, Anyang-si (KR)

(73) Assignee: LSIS CO., LTD., Anyang-si (KR)

(21) Appl. No.: 15/177,256

(22) Filed: Jun. 8, 2016

(30) Foreign Application Priority Data
Jul. 23, 2015 (KR) 10-2015-0104635

(51) Int. Cl. H01M 2/30; H01M 2/20; H01M 2/06; H01R 13/52; H01R 4/34

(52) U.S. Cl. CPC H01M 2/305; H01R 13/5202; H01R 4/34; H01M 2/06; H01M 2/206; H01M 2220/20

(57) ABSTRACT

An external connector according to the present invention is connected to a battery pack provided with a battery module, a converter stepping down a voltage of the battery module to output to the exterior and stepping up an externally-input voltage to supply to the battery module, and a case accommodating the battery module and the converter therein, and the external connector includes a connector plate coupled to a connector exposing opening formed through the case so as to hermetically seal the connector exposing opening, and coupling bolts each having one end inserted into the connector plate and another end exposed, and connection bus bars each having one end forming a connection terminal and inserted into the connector plate so as to be exposed in the same direction as the coupling bolt, and another end coupled to a corresponding main bus bar connected to the battery module and the converter.

### CROSS-REFERENCE TO RELATED APPLICATION

Pursuant to 35 U.S.C. §119(a), this application claims the benefit of earlier filing date and right of priority to Korean Patent Application No. 10-2015-0104635, filed on Jul. 23, 2015, the contents of which are all hereby incorporated by reference herein in its entirety.

### BACKGROUND OF THE INVENTION

1. Field of the Invention

This specification relates to an external connector of a battery pack for a vehicle, and more particularly, an external connector applied to a vehicle battery pack which is used as a power source of a driving motor of a mild hybrid vehicle.

2. Background of the Invention

A hybrid vehicle refers to a vehicle which is driven by efficiently combining two or more different types of power sources, but in most cases, refers to a vehicle which is driven by an engine obtaining a rotational force in a manner of burning fuels (fossil fuels such as gasoline, diesel, etc.) and an electric motor obtaining a rotational force from battery power.

The hybrid vehicle is a futuristic vehicle which can reduce exhaust gas and improve fuel efficiency by employing an electric motor as a sub power source as well as an engine. Active researches for the hybrid vehicle are undergoing to meet the needs of the times that the fuel efficiency should be improved and eco-friendly products should be developed.

The hybrid vehicle is classified into a mild type, a middle type and a hard type according to a power sharing ratio between an engine and an electric motor.

A type in which a capacity of the driving motor is smaller than that of the engine is referred to as a hybrid system. In general, there is not a mode in which a vehicle is driven merely by the driving motor in a mild hybrid system. On the other hand, there is a mode of driving a vehicle using a motor at low speed in a hard type hybrid system employing a motor with a great capacity.

For an automobile, electric components of the automobile use a voltage of 12V. The mild hybrid type further requires for an auxiliary high-voltage battery (e.g., 48V) for using and charging a large capacity of electric energy.

The auxiliary battery of the mild hybrid vehicle is provided in a battery pack in the form of a battery module, and the battery pack is connected with an external connector.

FIG. 1 is a view illustrating a structure of an external connector of a battery pack according to the related art.

An external connector 16 connected to a battery pack 10 includes coupling bolts 30, 31, 32 formed of a metallic conductor with high electric conductivities, main bus bars 20, 21, 22, and a connector plate 40 made of a synthetic resin material with an insulating property.

The external connector 16 is fabricated such that the coupling bolts 30, 31, 32, the main bus bars 20, 21, 22 and the connector plate 40 are integrally formed through a so-called insert-molding method of injecting synthetic resin in a state that the coupling bolts 30, 31, 32 and the main bus bars 20, 21, 22 have been inserted into a mold.

The main bus bars 20, 21, 22 of the thusly-fabricated external connector 16 are inserted through a connector exposing opening 12 which is formed through one side surface of a case 11, and the connector plate 40 is hermetically coupled to the case 11 having the connector exposing opening 12 in a thermal-bonding manner.

However, the method of coupling the connector plate 40 to the one side surface of the case 11 limits the installation position of the external connector 16 to only the one side surface of the case, and thereby causes a problem of failing to meet demands of users (customers) who desire to install the external connector at various positions.

Since the connector plate 40 is installed to protrude perpendicular to a side surface of the case 11, the external connector 16 is damaged or destroyed while using the battery pack 10.

Also, since the connector plate 40 is coupled in the manner of being thermally bonded to the case 11 having the connector exposing opening 12, a replacement of the external connector 16 is not allowed even though the external connector 16 is damaged. This results in having to replace the whole battery pack 10 connected with the external connector 16.

Furthermore, to thermally bond the connector plate 40 to the case 11, a separate thermal bonding process should be executed.

### SUMMARY OF THE INVENTION

Therefore, an aspect of the detailed description is to provide an external connector applied to a battery pack for a mild hybrid vehicle with an embedded converter.

Another aspect of the detailed description is to improve the degree of freedom of designing other devices adjacent to a battery pack by providing a structure which allows for freely setting a position of an external connector with respect to a case.

Another aspect of the detailed description is to provide an external connector structure, capable of simply hermetically sealing an external connector in a case even without an execution of a thermal-bonding process.

Another aspect of the detailed description is to provide an external connector structure, capable of detaching and attaching an external connector from and to a case in a simple manner.

Another aspect of the detailed description is to prevent damage or destroy of an external connector while using a battery pack, by minimizing a protruded degree of a connector plate from a case.

To achieve these and other advantages and in accordance with the purpose of this specification, as embodied and broadly described herein, there is provided an external connector connected to a battery pack comprising a battery module, a converter stepping down a voltage of the battery module to output to the exterior and stepping up an externally-input voltage to supply to the battery module, and a case accommodating the battery module and the converter therein, the external connector including a connector plate coupled to a connector exposing opening formed through the case so as to hermetically seal the connector exposing opening, and coupling bolts each having one end inserted into the connector plate and another end exposed, and connection bus bars each having one end forming a connection terminal and inserted into the connector plate so as to be exposed in the same direction as the coupling bolt, and another end coupled to a corresponding main bus bar connected to the battery module and the converter.

Here, the external connector may be installed on one surface of the case, and the connection bus bars may be changed in shape to be coupled to the main bus bars according to a position at which the external connector is coupled to the case.

The connector plate may be coupled to an inner surface of the case in a surface-contact manner such that the coupling bolts and the connection terminals are exposed to the outside of the case through the connector exposing opening.

A sealing portion may be provided between coupling surfaces of the connector plate and the case.

The sealing portion may form a closed loop along an edge of the connector plate to surround the coupling bolts and the connection terminals.

The sealing portion may include a recess formed on the connector plate, the case or each of the connector plate and the case, and a sealing ring inserted into the recess to seal a gap between the connector plate and the case.

The sealing portion may be formed in a manner of coating a sealing material between the connector plate and the case.

A coupling direction that the connector plate is coupled to the case may correspond to a lengthwise direction of the coupling bolts.

The connection bus bars may be coupled to the main bus bars by use of bolts. Position fixing guides may be provided on both sides of a lower end of at least one of the connection bus bars, so as to be supported on side surfaces of the main bus bar to prevent the connection bus bar from being rotated with respect to the main bus bar due to a rotation of the bolt upon coupling the connection bus bar to the main bus bar by using the bolt.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a view illustrating an external connector structure for a battery pack according to the related art;

FIG. 2 is a configuration view illustrating a structure of a battery pack with an external connector in accordance with the present invention;

FIG. 3 is a perspective view of a battery pack with an external connector in accordance with an embodiment of the present invention;

FIG. 4 is a perspective view illustrating an external connector of a battery pack in accordance with an embodiment of the present invention;

FIG. 5 is a sectional view illustrating a coupled state between an external connector and a case in accordance with an embodiment of the present invention; and

FIG. 6 is an exemplary view illustrating a connection relationship between a connection bus bar and a main bus bar in accordance with an embodiment of the present invention.

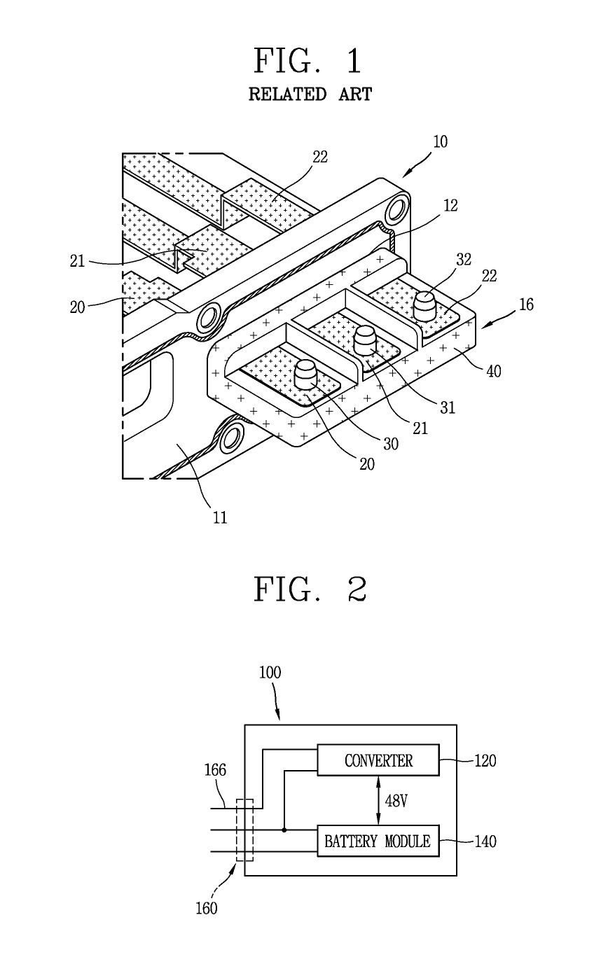

### DETAILED DESCRIPTION OF THE INVENTION

Terms or words used in this specification and claims should not be interpreted to be limited to typical meaning or definitions in the dictionary, but be interpreted as meaning and concepts appropriate for the technical scope of the present invention on the basis of the principle that the inventor can appropriately define conceptions of terms to explain the invention in the best manner. Also, the configuration illustrated in the embodiments and drawings of this specification are merely the most preferable embodiment, and may not represent all of the technical scope of the present invention. Therefore, it should be understood that there may be various equivalents and variations to replace the embodiments at the time point that this application is applied.

FIG. 2 is a configuration view illustrating a structure of a battery pack with an external connector in accordance with the present invention.

As illustrated in FIG. 2, a battery pack 100 includes a battery module 140 having a relatively higher voltage than an electronic battery of a vehicle, a converter 120 to step down a voltage of the battery module 140 to output to the exterior or step up an externally-input voltage (a voltage supplied from the electronic battery or a power plant) to supply to the battery module 140, and an external connector 160 connected to an input/output terminal of the vehicle.

The electronic battery of the vehicle generally uses a voltage of 12V. Hereinafter, description will be given under assumption that the voltage of the electronic battery is 12V and a voltage of the battery module is 48V.

The battery pack 100 with the external connector according to the present invention is to supply power to a driving motor of a mild hybrid vehicle, and provided with the battery module 140 having the voltage of 48V. Since the mild hybrid vehicle does not use a general starter motor but uses a driving motor with a greater capacity than that of the starter motor, the high-voltage battery module 140 is required for supplying power to the driving motor.

However, even for the mild hybrid vehicle, electrical components are driven by the voltage of 12V in the same way as general cars. To this end, the mild hybrid vehicle is equipped with an electrical battery using the voltage of 12V, and a power generator generating power of the voltage of 12V.

The converter 120 supplies power of the battery pack 100 to the driving motor or steps down the voltage of the battery pack 100 to supply to the electrical battery, according to a driving state of the vehicle.

Explaining this in more detail, the converter 120 steps the voltage of 12V up to the voltage of 48V and steps the voltage of 48V down to the voltage of 12V. Upon supplying power of the battery module 140 to the driving motor, the voltage of 48V is supplied as it is. Therefore, the voltage adjustment by the converter 120 is not needed. However, to supply the power of the battery module 140 to electrical components of the vehicle or the like, the voltage of the battery module 140 should be stepped down to 12V. Also, in order to charge the battery module 140 with the voltage of 12V which is input from outside, the voltage of 12V should be stepped up to the voltage of 48V.

Connection bus bars 166 of the external connector 160 may be configured as a 12V-input/output terminal, a 48V-output terminal, and a common earthing terminal, respectively. The voltage of 12V may be supplied from the converter 120 to the electrical battery or from the electrical battery to the converter 120. The voltage of 48V is supplied to the driving motor.

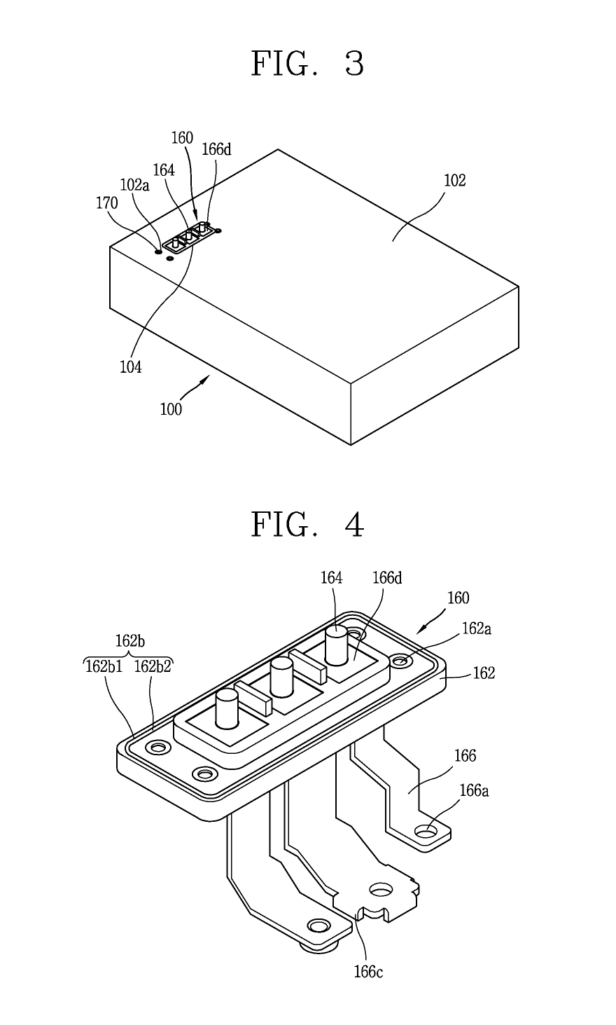

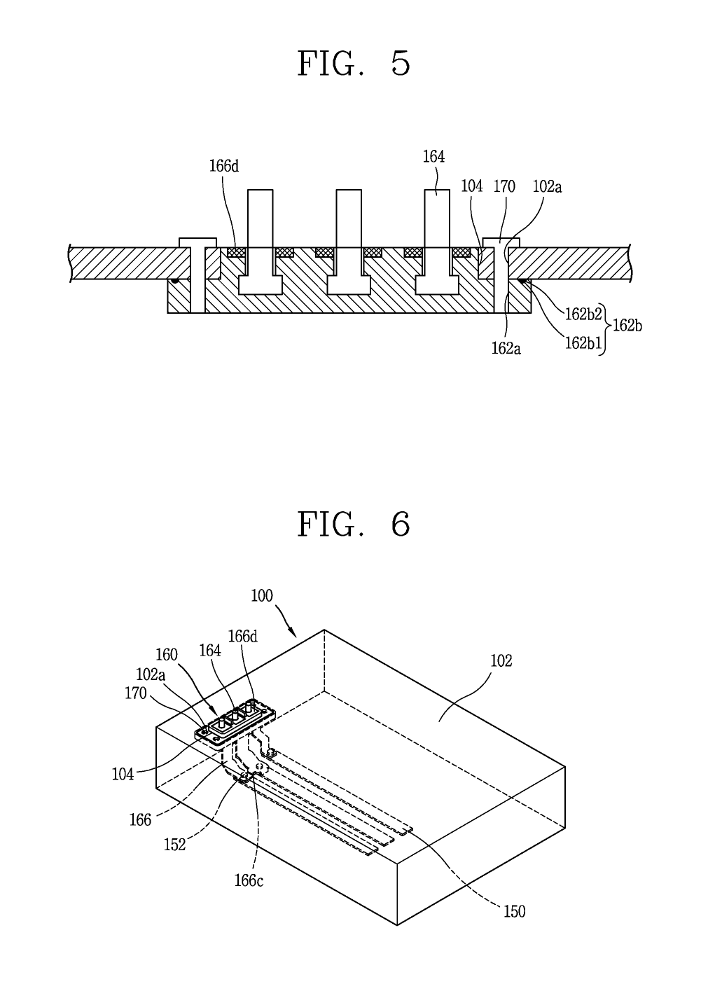

FIG. 3 is a perspective view of a battery pack with an external connector in accordance with an embodiment of the present invention, FIG. 4 is a perspective view illustrating an external connector of a battery pack in accordance with an embodiment of the present invention, FIG. 5 is a sectional view illustrating a coupled state between an external connector and a case in accordance with an embodiment of the present invention, and FIG. 6 is an exemplary view illustrating a connection relationship between a connection bus bar and a main bus bar in accordance with an embodiment of the present invention.

An external connector 160 according to an embodiment of the present invention may be selectively installed on any one surface of a case 102 of the battery pack 100 by changing a design according to a user's demand.

For the sake of explanation, the following description will be given, as illustrated in FIGS. 3 and 6, under assumption that the one surface is an upper surface of the case 102.

As illustrated in FIGS. 3, 5 and 6, a connector exposing opening 104 is formed through an upper surface of the case 102. A separately-fabricated external connector 160 is coupled to the connector exposing opening 104.

This will be described in more detail with reference to FIGS. 2 to 6. The external connector 160 of the battery pack 100 in accordance with the embodiment of the present invention includes a connector plate 162 coupled to the connector exposing opening 104 to seal the connector exposing opening 104, coupling bolts 164 each having one end inserted (buried) into the connector plate 162 and another end exposed; and connection bus bars 166 each having one end forming a connection terminal 166d and inserted into the connector plate 164 to be exposed in the same direction as the corresponding coupling bolt 164, and another end coupled to a corresponding main bus bar 150 which is connected to the battery module 140 and the converter 120.

The connector plate 162 is made of a synthetic resin material having an insulating property.

The coupling bolts 164 and the connection bus bars 166 are formed of a metallic conductor with high electric conductivity.

The external connector 160 is fabricated in a manner that the coupling bolts 164, 31, 32, the connection bus bars 166 and the connector plate 162 are integrally formed through a so-called insert-molding method of injecting synthetic resin into a mold in a state that the coupling bolts 164 and the connection bus bars 166 are inserted.

Here, the connector plate 162 is coupled to an inner surface of the case 102 in a surface-contact manner such that the coupling bolts 164 and the connection terminals 166d are exposed to the outside of the case 102 through the connector exposing opening 104.

In this manner, the connector plate 162 may be coupled to the inner surface of the case 102 in the surface-contact manner, and thus the connector plate 162 cannot protrude to the outside of the case 102.

That is, only portions required for the connection of the external connector 160, namely, the coupling bolts 164 and the connection terminals 166d merely externally protrude.

Therefore, unlike the external connector 16 according to the related art, the external connector 160 does not protrude out of the case 102, except for the coupling bolts 164 and the connection terminals 166d. This may result in minimizing damage or destroy of the external connector 160 during the use of the battery pack 100.

Meanwhile, as illustrated in FIG. 4, the connector plate 162 is provided with coupling holes 162a for coupling the connector plate 162 to the case 102. Also, as illustrated in FIG. 5, the case 102 is provided with coupling holes 102a at positions corresponding to the coupling holes 162a of the connector plate 162. Accordingly, the connector plate 162 and the case 102 are simply coupled to each other by coupling those coupling holes 162a and 102a using coupling bolts 170.

Here, a coupling direction that the connector plate 162 and the case 102 are coupled to each other preferably corresponds to a protruding direction, namely, a lengthwise direction of the coupling bolt 164. This is to stably support the connector plate 162 on the case 102 with respect to a rotation weight applied to the coupling bolts 164 due to screws (not illustrated) when the screws are coupled to the coupling bolts 164 after inserting a ring terminal (not illustrated) into the coupling bolt 164.

Meanwhile, depending on a position where the external connector 160 is installed on the case 102, the connection bus bar 166 may change in shape so as to be coupled to the main bus bars 150.

Here, the change in the shape of the connection bus bar 166 refers to decreasing or increasing a length of the connection bus bar 166. The length of the connection bus bar 166 may be set at its designing step, or adjusted according to an operator's need in a bending manner (see FIG. 4).

The present invention may enable an installation position of the external connector 160 to freely change with respect to the case 102 in a manner of fabricating the external connector 160, separate from the main bus bars 150, and coupling the separately-fabricated external connector 160 to the main bus bars 150 by virtue of the change in the shape of the connection bus bars 160 coupled to the main bus bars 150. Therefore, according to the present invention, the degree of freedom of designing other devices (not illustrated) adjacent to the battery pack 100 can be improved.

As illustrated in FIG. 4, coupling holes 166a for coupling of the main bus bars 150 may be formed on lower ends of the connection bus bars 166, respectively. As illustrated in FIG. 6, it can be noticed that the connection bus bars 166 are coupled to the main bus bars 150 installed within the case 102 by inserting bolts 152 through the coupling holes 166a (not illustrated in FIG. 6), respectively.

As illustrated in FIGS. 4 and 6, position fixing guides 166c which are supported by side surfaces of the main bus bar 150 may be formed on both sides of a lower end of at least one of the connection bus bars 166, for example, a middle connection bus bar 166, to prevent the connection bus bar 166 from being rotated due to the main bus bar 150 while the connection bus bar 166 is coupled to the main bus bar 150 by inserting the bolt 152 through the coupling hole 166a.

Meanwhile, since the connector plate 162 and the case 102 are coupled to each other in the surface-contact state, a sealing portion 162b is needed between coupling surfaces of the connector plate 162 and the case 102 to prevent an introduction of foreign materials and water into the case 102.

To this end, the sealing portion 162b which is formed in a closed-loop shape to surround the connection bolts 164 and the connection terminals 166d may be provided on a gap (or portion) between the connector plate 162 and the case 102.

Here, the sealing portion 162b may be provided with a recess 162b1 that is made of an elastic material and formed on the connector plate 162, the case 102 or each of the connector plate 162 and the case 102, and a sealing ring 162b2 inserted into the recess 162b1 to seal the gap between the connector plate 162 and the case 102.

The sealing portion 162b, as aforementioned, may be configured in the shape of the sealing ring 162b2, for example, a rubber ring inserted into the recess 162b1, but may alternatively be configured in a manner of simply coating a sealing material (not illustrated) made of silicon between the connector plate 162 and the case 102, without forming the recess 162b1.

The present invention may provide the sealing portion 162b on a contact surface between the connector plate 162 and the case 102, to ensure a sealed state of a coupled portion between the external connector 160 and the case 102 merely by coupling the connector plate 162 to the case 102.

The present invention, as aforementioned, may not execute the thermal-bonding process, and this may allow the external connector 160 to be attached to or detached from the case 102 in a simple coupling manner.

Therefore, the present invention can simplify a replacement of the external connector 160 upon an occurrence of damage on the external connector 160.

It should be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An external connector connected to a battery pack comprising a battery module, a converter stepping down a voltage of the battery module to output to the exterior and stepping up an externally-input voltage to supply to the battery module, and a case accommodating the battery module and the converter therein, the external connector comprising:
a connector plate coupled to a connector exposing opening formed through the case so as to hermetically seal the connector exposing opening; and
coupling bolts each having one end inserted into the connector plate and another end exposed; and
connection bus bars each having one end forming a connection terminal and inserted into the connector plate so as to be exposed in the same direction as the coupling bolt, and another end coupled to a corresponding main bus bar connected to the battery module and the converter.

2. The external connector of claim 1, wherein the external connector is installed on one surface of the case, and
wherein the connection bus bars are changed in shape to be coupled to the main bus bars according to a position at which the external connector is coupled to the case.

3. The external connector of claim 2, wherein the connector plate is coupled to an inner surface of the case in a surface-contact manner such that the coupling bolts and the connection terminals are exposed to the outside of the case through the connector exposing opening.

4. The external connector of claim 3, wherein a sealing portion is provided between coupling surfaces of the connector plate and the case.

5. The external connector of claim 4, wherein the sealing portion forms a closed loop along an edge of the connector plate to surround the coupling bolts and the connection terminals.

6. The external connector of claim 5, wherein the sealing portion comprises a recess formed on the connector plate, the case or each of the connector plate and the case, and a sealing ring inserted into the recess to seal a gap between the connector plate and the case.

7. The external connector of claim 5, wherein the sealing portion is formed in a manner of coating a sealing material between the connector plate and the case.

8. The external connector of claim 1, wherein a coupling direction that the connector plate is coupled to the case corresponds to a lengthwise direction of the coupling bolts.

9. The external connector of claim 1, wherein the connection bus bars are coupled to the main bus bars by use of bolts, and
wherein position fixing guides are provided on both sides of a lower end of at least one of the connection bus bars, the position fixing guides being supported on side surfaces of the main bus bar to prevent the connection bus bar from being rotated with respect to the main bus bar due to a rotation of the bolt upon coupling the connection bus bar to the main bus bar by using the bolt.
